(19) United States
(12) Patent Application Publication
(10) Pub. No.: US 2026/0030273 A1
(43) Pub. Date: Jan. 29, 2026

(54) INFORMATION PROCESSING EDGE DEVICE AND INFORMATION PROCESSING METHOD FOR EDGE DEVICE FUNCTION SETTING

(71) Applicant: Toshiba Tec Kabushiki Kaisha, Tokyo (JP)

(72) Inventor: Takahiro OGISU, Izunokuni Shizuoka (JP)

(21) Appl. No.: 19/216,186

(22) Filed: May 22, 2025

(30) Foreign Application Priority Data
Jul. 25, 2024 (JP) 2024-120300

(51) Int. Cl. G06F 16/3329; G06F 16/335

(52) U.S. Cl. CPC G06F 16/33295; G06F 16/335

(57) ABSTRACT

According to one embodiment, an edge device includes a communication interface connectable to an edge server, a storage unit for storing a dialogue LLM trained to interact with a user for setting a function of the edge device and a database storing reference information related to functions of the edge device. A controller unit receives request text input indicating a user's desired process to be provided using the edge device, then inputs the request text input to a generative AI that is based on the dialogue LLM and can access the database to identify a function of the edge device that can provide the user's desired process. The controller unit outputs confirmation question text to confirm the identified function corresponds to the user's desired process, and then sets the edge device to execute the identified function if confirmed.

### CROSS-REFERENCE TO RELATED APPLICATION

This application is based upon and claims the benefit of priority from Japanese Patent Application No. 2024-120300, filed Jul. 25, 2024, the entire contents of which are incorporated herein by reference.

### FIELD

Embodiments described herein relate generally to information processing edge devices and an information processing method for setting functions of edge devices.

### BACKGROUND

In related art, so called “edge devices” are used for research, analysis, problem solving, and other purposes specific to the user or the environment in which an edge device is used. Edge devices therefore typically do not have fixed uses as supplied, but are connected to various sensors or sensing devices to realize various purposes by using functions (for example, artificial intelligence processing) related to processing the sensed data for research and problem solving solutions.

There are proposed technologies for adding functions to, or changing the functions of, edge devices by downloading such functions or modifications from an external platform, providing an API as a platform, or using other methods. For example, a flow design tool such as Node-red is used to set the order in which functions are called.

The procedures described above are easy for designers and edge device producers to provide, but are difficult in many cases for end users who conduct the on-site research, analysis, solution examination, operations, or the like, to implement and may thus hinder the use of edge devices by intended end users.

### BRIEF DESCRIPTION OF THE DRAWINGS

FIG. 1 depicts a schematic configuration of an information processing system according to an embodiment.

FIG. 2 is a block diagram of an edge device according to an embodiment.

FIG. 3 is a block diagram of an edge server according to an embodiment.

FIG. 4 is a block diagram depicting certain functional aspects of an edge device according to an embodiment.

FIG. 5 is a block diagram depicting certain functional aspects of an edge server of an embodiment.

FIG. 6 is a flowchart of processes carried out by an edge device of an embodiment.

### DETAILED DESCRIPTION

In general, according to one embodiment, there is provided an information processing edge device and an edge device information processing method that can readily arrange, combine, and/or provide operations or functions of an edge device to permit end users to perform processing according to their own preferences or intentions.

According to an embodiment, an information processing edge device includes a communication interface connectable to an edge server via a network, a storage unit for storing a dialogue LLM (trained to interact with a user for setting a function of an edge device) and a database (storing reference information related to functions of the edge device), and a controller. The controller is configured to: receive request text input indicating a user's desired process to be provided using the edge device; input the request text input to a generative AI based on the dialogue LLM and configured to access the database to identify a function that can be executed by the edge device to provide the user's desired process; output confirmation question text generated by the generative AI to confirm the identified function corresponds to the user's desired process; and set the edge device to execute the identified function if the user responds affirmatively to confirmation question text.

An information processing apparatus and an information processing method according to certain example embodiments will be described below with reference to the drawings. In an embodiment described below, an edge server is installed in a store such as a department store or a supermarket as an example of the information processing apparatus, but the present disclosure is not limited to this example embodiment.

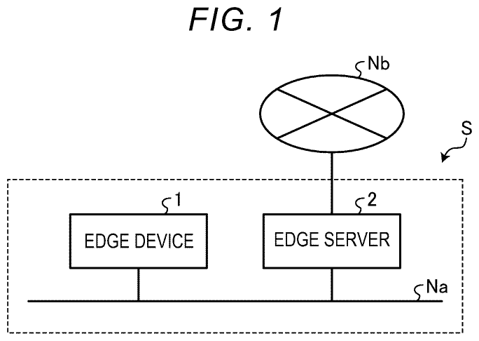

FIG. 1 is a schematic configuration of an information processing system S according to an embodiment. The information processing system S includes an edge device 1 and an edge server 2, as shown in FIG. 1.

The edge device 1 and the edge server 2 are communicatively connected to each other via a network Na such as a LAN (local area network). The edge server 2 is further communicatively connected to a network Nb such as the Internet.

Note that the number of edge devices 1 connected to the edge server 2 is not limited to the number in the illustrated example.

The edge device 1 is an apparatus installed onsite at a store. The edge device 1 is used by a store manager or other user. For example, the edge device 1 may be a smartphone, a tablet terminal, a PC (personal computer), or the like.

In this example, the edge device 1 uses generative AI to engage in dialogue with the user, identifies the user's desired function to be implemented and the user's desired settings for the function, and carries out the process of providing the user with the function.

The edge server 2 is a server apparatus installed in the store or a data center outside the store. The edge server 2 cooperates with the edge device 1 to provide the user with a function that the edge device 1 cannot provide by itself.

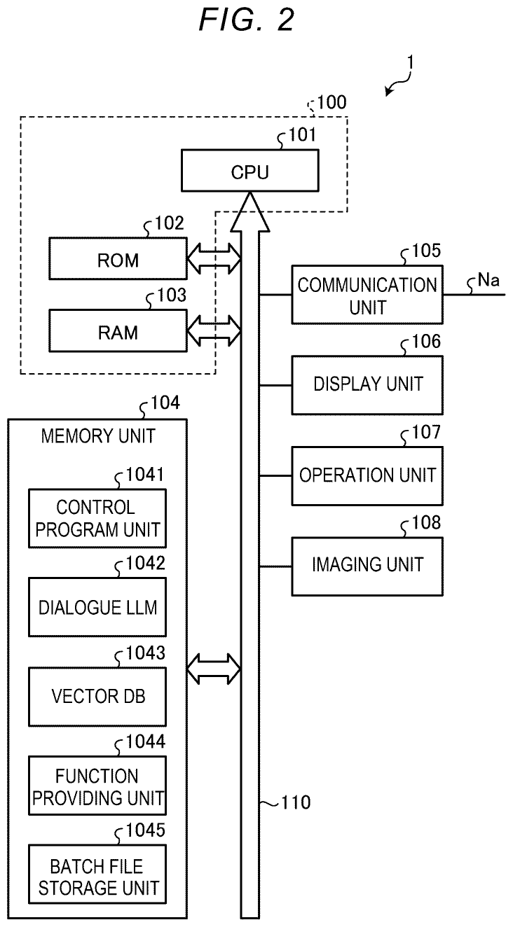

The hardware configuration of the edge device 1 will next be described. FIG. 2 is a block diagram showing an example of the hardware configuration of the edge device 1 according to an embodiment.

The edge device 1 includes a CPU (central processing unit) 101, which is one example of a processor, a ROM (read only memory) 102, a RAM (random access memory) 103, and a memory unit 104 (storage unit), as shown in FIG. 2.

The CPU 101 controls each sub-unit of the edge device 1. The ROM 102 stores various programs. The RAM 103 is a workspace where the programs and various data are loaded.

The memory unit 104 is a nonvolatile memory such as an HDD (hard disc drive) or a flash memory, which holds stored information even when the power is turned off. The memory unit 104 includes a control program unit 1041, a dialogue LLM 1042, a vector database (DB) 1043, a function providing unit 1044, and a batch file storage unit 1045.

The control program unit 1041 stores a control program for controlling the edge device 1. The CPU 101, the ROM 102, the RAM 103, and the memory unit 104 are connected to each other via a bus 110. The CPU 101, the ROM 102, and the RAM 103 constitute a controller 100 having the configuration of a computer. That is, the controller 100 controls the edge device 1 by the CPU 101 operating in accordance with the control program unit 1041 stored in the ROM 102 or the memory unit 104 and loaded into the RAM 103.

The dialogue LLM 1042 is a generative AI program or model that generates text. For example, the dialogue LLM 1042 is a large language model (LLM). The dialogue LLM 1042 is used to generate dialogue text for identifying a user's desired function to be implemented by the edge device 1. In the embodiment, an LLM is used as the generative AI, but the generative AI is not limited to an LLM and any other method or component that is capable of generating text can be adopted.

In this example, the dialogue LLM 1042 is an LLM that is constructed based on a known deep learning technology to provide (output) a response to the input of text specifying a condition. For example, the condition may be a reference condition that serves as a reference point or key for deriving a text response for output or a constraint condition that provides information for narrowing down a final output response.

For example, the dialogue LLM 1042 generates text data such as a one side of a dialogue text. The dialogue text can include text data describing or specifying the name of a function to be provided to the user, text data providing a description of the provided function, and a confirmation sentence asking whether a provided function is the user's actually desired function.

Note that the dialogue text may be text data describing the names of multiple provided functions, a description of each of the multiple provided functions, or a confirmation sentence asking whether the multiple provided functions include the user's desired function.

The dialogue LLM 1042 in the present embodiment operates on an instruction sentence that instructs generation of a dialogue text and a request text that indicates the user's request. The dialogue LLM 1042 generates a dialogue text corresponding to the user's request after input of an instruction text (hereinafter also referred to as a prompt). The dialogue text may be generated on the basis of an added condition that the function incorporated in the dialogue text in response to the request text be derived from within the area of the information stored in the vector DB 1043.

The vector DB 1043 is a database to which the dialogue LLM 1042 can refer based on a retrieval-augmented generation (RAG) approach.

The RAG approach uses a retriever to extract external knowledge, explicitly adds the extracted external knowledge to the prompt, and performs in-context learning on the LLM. In this context, the retriever is a system that searches for the external knowledge closest to a question sentence (whether input by the system or the user) based on sentence surface information or sentence embedding.

It is generally considered that use of the RAG approach can improve the performance of an LLM and prevent the generative AI from generating information that is not based on facts (hallucination). Therefore, in the present embodiment, the edge device 1 can use a RAG approach to prevent the dialogue LLM 1042 from proposing any functions outside the contents in the vector DB 1043.

In the present embodiment, the vector DB 1043 stores documents in the form of vectors (vectorized information). These documents may, for example, explain how to use various functions that the edge device 1 permits a user to use. The documents may include, for example, overviews of a function or functions, use cases, download sites, a command-line-based calling method, and answers to questions regarding how to set parameters for a function or functions.

The function providing unit 1044 stores data or other pieces of information related to realizing a function identified by using the dialogue LLM 1042. In this context, the related data may be applications, plug-ins, scripts, setting information, and the like for implementing or otherwise providing a function. For example, the function providing unit 1044 may store multiple applications that are independent of each other but used in combination to realize a function that is frequently desired by the user.

The batch file storage unit 1045 is a file for performing a user's desired (selected) function after such has been identified by using the dialogue LLM 1042. The file (e.g., a batch file) may include content (“setting content”) necessary for setting a function to perform according to a user's preferences, requests, or instructions. The user's desired function can be realized by executing the batch file in the batch file storage unit 1045.

The controller 100 is connected to a communication unit 105, a display unit 106, an operation unit 107, and an imaging unit 108 (a sensing unit) via the bus 110.

The communication unit 105 is a communication interface, such as a LAN I/F (interface), and is connected to a network Na. The communication unit 105 transmits and receives various pieces of information to and from the edge server 2 via the network Na.

The display unit 106 is a display device such as an LCD (liquid crystal display) or an organic EL (electro-luminescence) display. The display unit 106 displays various pieces of information relating to the edge device 1 under the control of the CPU 101.

The operation unit 107 is realized, for example, as a touch panel. The operation unit 107 accepts various inputs from the user. The operation unit 107 may instead be an input device such as a keyboard or a pointing device. The operation unit 107 may further accept various inputs from the user via a voice input device such as a microphone.

The imaging unit 108 is an imaging apparatus. The imaging unit 108 is one example of a sensor or sensing device that might be connected to, or incorporated in, edge device 1. The imaging unit 108 in this example includes a solid-state imaging element such as a CCD (charge coupled device) or a CMOS (complementary MOS) device. In the present embodiment, multiple imaging units 108 can be provided inside the store. For example, the imaging units 108 capture images of customers (visitors) who enter the store.

Note that components other than those described above may be connected to the controller 100. For example, in addition to the above, or instead, a sensing device, such as a temperature sensor, and an output device, such as a printer, may be connected to the controller 100. In other examples, some of the components described above may not be connected to the controller 100.

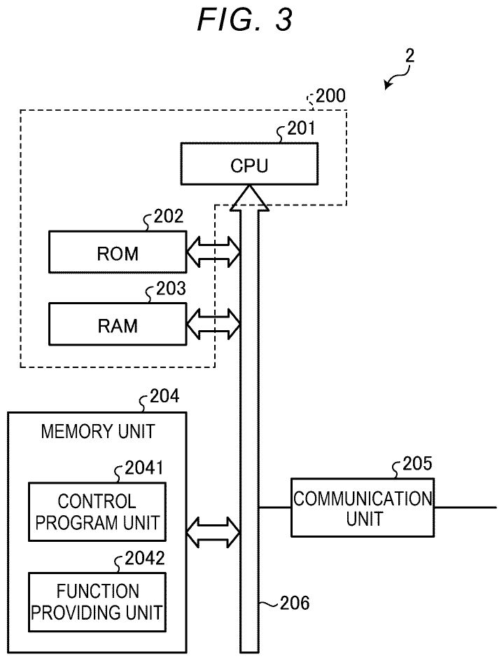

The hardware configuration of the edge server 2 will next be described. FIG. 3 is a block diagram showing an example of the hardware configuration of the edge server 2.

The edge server 2 includes a CPU 201, which is an example of a processor, a ROM 202, a RAM 203, and a memory unit 204, as shown in FIG. 3.

The CPU 201 controls each sub-unit of the edge server 2. The ROM 202 stores various programs. The RAM 203 is a workspace where the programs and various data are loaded.

The memory unit 204 is a nonvolatile memory such as an HDD or a flash memory, which holds stored information even when the power is turned off. The memory unit 204 includes a control program unit 2041 and a function providing unit 2042.

The control program unit 2041 stores a control program for controlling the edge server 2. The CPU 201, the ROM 202, the RAM 203, and the memory unit 204 are connected to each other via a bus 206. The CPU 201, the ROM 202, and the RAM 203 constitute a controller 200 having the configuration of a computer. That is, the controller 200 controls the edge server 2 by the CPU 201 operating in accordance with the control program unit 2041 stored in the ROM 202 or the memory unit 204 and loaded into the RAM 203.

Referring back to FIG. 3, the controller 200 is connected to a communication unit 205 via the bus 206.

The communication unit 205 is a communication interface, such as a LAN I/F, and is connected to the networks Na and Nb. The communication unit 205 transmits and receives various pieces of information to and from the edge device 1, an external server, and other components via the networks Na and Nb.

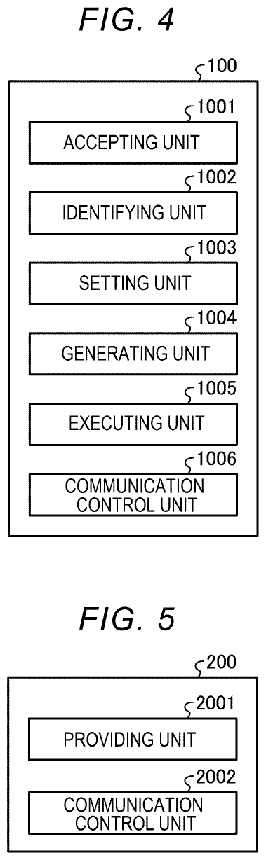

The functional configuration of the edge device 1 will next be described. FIG. 4 is a block diagram showing an example of the functional configuration of the edge device 1. The controller 100 includes, as a functional configuration or aspects thereof, an accepting unit 1001, an identifying unit 1002, a setting unit 1003, a generating unit 1004, an executing unit 1005, and a communication control unit 1006, as shown in FIG. 4. Note that the functional aspects provided in the edge device 1 are not limited to those described above.

Specifically, in the present example, the controller 100 (CPU 101) of the edge device 1 executes the control program unit 1041 stored in the memory unit 104 to realize the functional configuration described above. Note in the present embodiment that the functional configuration described above is a software configuration realized by cooperation between the processor of the edge device 1 and the programs of the edge device 1. In other examples, aspects, functions, operations, or portions thereof, described as implemented by a software configuration may be implemented by a hardware configuration in which a portion or the entirety of the functional configuration is realized by a dedicated circuit or the like.

The accepting unit 1001 accepts the input of a request text from the user. The request text is an example of demand information.

For example, when the user instructs activation of an application for selecting, constructing, or setting a function of the edge device 1, the accepting unit 1001 causes the display unit 106 to display a GUI (graphical user interface) for engaging in dialogue with the user for function construction or the like. As an example, the GUI has a display field where text generated by the dialogue LLM 1042 is displayed and an input field where the user inputs text.

Note in the present embodiment that the edge device 1 engages in dialogue with the user via the GUI, but the edge device 1 may also or instead engage in dialogue with the user via a CUI (character user interface) or otherwise. In some examples, edge device 1 may engage in dialogue with the user by voice (speech) without using the display unit 106. In this case, the edge device 1 includes a voice input device such as a microphone.

In parallel with the process described above, the accepting unit 1001 inputs text to the dialogue LLM 1042 corresponding to an instruction to generate a dialogue start text for starting the process of constructing a function based on the user's request (inputs). After the instruction, dialogue LLM 1042 generates dialogue start text.

In the embodiment, start text is, for example, “Functions can be constructed, so input what you want to do.” The accepting unit 1001 displays the dialogue start text in the display field. The accepting unit 1001 then accepts user inputs in the input field in response to the dialogue start text. The user input may serve as a request text or request sentence.

The start text generated by the dialogue LLM 1042 and the user's response to the start text are stored in the memory unit 104 and used by the dialogue LLM 1042 to generate additional dialogue text as necessary or appropriate.

As an example, the accepting unit 1001 accepts a request text from the user, stating “I want to measure the number of people using a camera.”

The identifying unit 1002 uses the vector DB 1043, (which stores reference information about functions that can be performed by the edge device 1) as an information source and inputs the request text and an instruction text to the dialogue LLM 1042. The instruction text instructs identification of a function that can realize the content of the process referenced or suggested in the request text. The dialogue LLM 1042 then generates and outputs information in response to the input information (text). The identifying unit 1002 then identifies a function that can realize the process or outcome desired by the user based on output from the dialogue LLM 1042.

The vector DB 1043 is an example of a storage unit. The instruction text is an example of the input information. The dialogue text is an example of the output information.

For example, the identifying unit 1002 extracts a sentence from the vector DB 1043 having a content closely matching the request text. The identifying unit 1002 uses the extracted sentence as context to generate an instruction text stating, for example, “Generate a proposal for the demand based on the context.” The identifying unit 1002 then inputs the generated instruction text into the dialogue LLM 1042.

The identifying unit 1002 acquires generated from the dialogue LLM 1042 in response to the input of the instruction text. The identifying unit 1002 displays the acquired dialogue text in the display field of the GUI.

In an example, it may be assumed that a user inputs a request text stating “I want to measure the number of people using a camera.”.

It may be further assumed that the vector DB 1043 stores a document describing a function called “visitor detection” and a document describing how to use the “visitor detection” function. One of these documents states “The visitor detection function measures the number of visitors based on their full-body images. The number of visitors can be estimated also when the visitors face sideways or backward, but the measurement involves looking at the entire body, so that measurement accuracy decreases when the visitors' entire bodies cannot be seen.”

In this case, the identifying unit 1002 vectorizes the request text (“I want to measure the number of people using a camera.”) and then searches the vector DB 1043 to extract a document having a vector close to “I want to measure the number of people using a camera.”

The request text and the document describing how to use a function called “visitor detection” will generally have similar vectors, so the identifying unit 1002 extracts the document describing how to use the function of “visitor detection” from the vector DB 1043.

The identifying unit 1002 may further extract the document describing the “visitor detection” function, which may be considered or determined to correspond to the document describing how to use the function of “visitor detection”. The identifying unit 1002 can thus identify (determine) that the function called “visitor detection” is an available function corresponding to the request text stating “I want to measure the number of people using a camera.”

The identifying unit 1002 next generates an instruction text instructing use of the extracted document as context for generation of a proposal in response to the user's request based. The identifying unit 1002 inputs the generated instruction text into the dialogue LLM 1042.

The dialogue LLM 1042 generates dialogue text in accordance with the input instruction text (using the document describing how to use the function called “visitor detection” as context). The dialogue text may state, “The visitor detection measures the number of visitors based on their full-body images. The number of visitors can be estimated also when the visitors face sideways or backward, but the measurement involves looking at the entire bodies, so that measurement accuracy decreases when the visitors' entire bodies cannot be seen. Do you want to construct the function?”

The identifying unit 1002 displays the generated dialogue text in the display field of the GUI.

If the user affirms the question, such as inputs, “Yes, I want to use the visitor detection.”, the identifying unit 1002 identifies the visitor detection function as the user's desired function from the initial request text stating “I want to measure the number of people using a camera.”

The setting unit 1003 next uses the dialogue LLM 1042 to set the user's desired function as identified by the identifying unit 1002.

For example, the setting unit 1003 inputs to the dialogue LLM 1042 an instruction text describing the name of the identified function and an instruction for generation of a setting start text for starting the setting of the user's desired function.

Information related to the setting start text is stored in the vector DB 1043 in association with a document describing the function. The dialogue LLM 1042 can thus refer to the vector DB 1043 to generate the setting start text corresponding to the function identified by the identifying unit 1002 from the name of the function contained in the instruction text input by the setting unit 1003.

Consider now a case where the identifying unit 1002 identifies the visitor detection function as the user's desired function. In this case, the dialogue LLM 1042 refers to the vector DB 1043 and identifies the setting start text associated with a document describing the function called “visitor detection”.

For example, when a document describing the function called “visitor detection” is associated with a setting start text stating “The number of visitors is saved along with time data. Is it OK that the recording interval is ten seconds?”, the dialogue LLM 1042 generates the setting start text described above as a setting start text for starting the setting for the visitor detection. The setting unit 1003 displays the generated setting start text described above in the display field.

When the user affirms the question, such as inputs “Yes”, as an answer to the setting start text, the setting unit 1003 sets the recording interval to ten seconds.

When the user responds negatively to the question, such as inputs “No”, the setting unit 1003 may input to the dialogue LLM 1042 an instruction text indicating that the user does not want the recording interval set to ten seconds, and an instruction of generation of a setting text for setting the recording interval to another value by referring to the vector DB 1043.

In this case, the vector DB 1043 may store a document describing the function called “visitor detection” and a question to be asked when the user does not want the recording interval set to ten seconds in association with each other.

The dialogue LLM 1042 can thus generate a question for setting the recording interval to another value. The setting unit 1003 displays the generated question in the display field of the GUI.

As an example, it is assumed that the document describing the function called “visitor detection” is associated with a setting text/question “How many seconds do you want to set the recording interval to? The recording interval can be set any value between XX and YY seconds.” to be displayed to the user when the user answers negatively to setting the recording interval to ten seconds.

In this case, the dialogue LLM 1042 generates a setting text “How many seconds do you want to set the recording interval to? The recording interval can be set any value between XX and YY seconds.” The setting unit 1003 displays the generated setting text described above in the display field.

In this case, the setting unit 1003 then sets the recording interval (number of seconds) based on input of the user's answer in response to the setting text/question described above.

The generating unit 1004 generates the user's desired function. For example, the generating unit 1004 generates a batch file for performing the user's desired function based on the function identified by the identifying unit 1002 and the setting content for the function set by the setting unit 1003.

As an example, the generating unit 1004 inputs to the dialogue LLM 1042 an instruction text stating “Answer the question based on the interaction with the user.” The generating unit 1004 then successively inputs the following questions to the dialogue LLM 1042: “What functions will you use?”; “How many seconds do you want to set the recording interval to?”; and the like.

The generating unit 1004 acquires information (e.g., answers) corresponding to each of the questions output from the dialogue LLM 1042. The generating unit 1004 then produces a batch file corresponding to a script calling method or the like in accordance with the acquired information.

After the identifying unit 1002 identifies the visitor detection function as the user's desired function and the setting unit 1003 sets the visitor detection recording interval to ten seconds (or as indicated by the user), the generating unit 1004 generates a batch file for detecting visitors (execute the visitor detection function) at the recording interval of ten seconds. The generating unit 1004 stores the generated batch file in the batch file storage unit 1045 of the memory unit 104.

Note that the batch file storage unit 1045 may store multiple batch files. In this case, the batch files may each be stored in the batch file storage unit 1045 in association with a file ID that particularly identifies the batch file, the name of the function performed by the batch file, and/or the setting content of the function to be performed.

When generating the batch files, the generating unit 1004 may also generate confirmation files (setting files), such as Node-red import files, and store the two types of files in the memory unit 104. Therefore, even when the user makes an unexpected mistake and is unable to perform the function correctly, information that is useful for investigating the cause of the malfunction can be left.

The executing unit 1005 now performs the user's desired function. For example, when the user instructs performing of the function, the executing unit 1005 executes the batch file(s) stored in the batch file storage unit 1045 of the memory unit 104.

For example, the executing unit 1005 executes the multiple applications stored in the function providing unit 1044 of the memory unit 104 in combination and/or in accordance with the contents of the batch files. Before executing the batch files, the executing unit 1005 determines whether the multiple applications stored in the function providing unit 1044 include all the applications for realizing the contents of the batch files.

When the executing unit 1005 determines that an application for realizing the content of at least one batch file is not among the multiple applications stored in the function providing unit 1044, the executing unit 1005, in cooperation with the communication control unit 1006, transmits a provision demand demanding provision of any missing application necessary for execution of a batch file to the edge server 2. For example, the provision demand contains an application ID that identifies the missing application being requested/demanded.

The executing unit 1005 stores, in the function providing unit 1044, the application transmitted from the edge server 2 in response to the provision demand. Thereafter, the executing unit 1005 again checks that all the required applications for realizing the contents of the batch files are stored in the function providing unit 1044, and then executes the batch files.

Note that, in some examples, the executing unit 1005 may cause the edge server 2 to execute one or more applications related to the contents of the batch file(s), for example, by using an API (application interface) and then acquire only the results of the execution of the application(s) from the edge server 2.

As an example, consider a case where a batch file is executed for performing the visitor detection function at the recording interval of ten seconds. In this case, the executing unit 1005 acquires images captured by each of multiple imaging units 108 every ten seconds in accordance with the batch file setting. The executing unit 1005 then uses an image recognition technology (corresponding to the visitor detection function) to estimate the number of visitors from the full-body images of the visitors, and stores the result of the estimation in the memory unit 104.

The communication control unit 1006 controls communication with the edge server 2 and transmits and receives various pieces of information.

Specifically, when the executing unit 1005 determines that a necessary application is not stored in the function providing unit 1044, the communication control unit 1006 transmits the provision demand to the edge server 2. The communication control unit 1006 receives the necessary application from the edge server 2 in response to the provision demand.

The functional configuration of the edge server 2 will next be described. FIG. 5 is a block diagram showing an example of the functional configuration of the edge server 2. The controller 200 includes a providing unit 2001 and a communication control unit 2002 as functional configuration, as shown in FIG. 5. Note that the functional configuration of the edge server 2 is not limited to that described above.

Specifically, the controller 200 (CPU 201) of the edge server 2 executes the control program stored in the control program unit 2041 of the memory unit 204 to realize the functional configuration described above. Note in the embodiment that the functional configuration described above is software configuration realized by cooperation between the processor of the edge server 2 and programs, but may be hardware configuration in part or the entirety.

When the edge device 1 alone cannot realize the user's desired function, the providing unit 2001 provides the edge device 1 with data or the like for realizing the desired function. For example, when the providing unit 2001 receives the provision demand from the edge device 1, the providing unit 2001 determines whether an application corresponding to the application ID contained in the provision demand is stored in the function providing unit 2042 of the memory unit 204.

When the providing unit 2001 determines that the corresponding application is stored in the function providing unit 2042, the providing unit 2001, in cooperation with the communication control unit 2002, transmits the corresponding application to the edge device 1.

Note that when the provision unit 2001 receives the provision demand, the provision unit 2001 may execute the corresponding application stored in the function providing unit 2042, for example, by using an API, in accordance with the batch files generated by the edge device 1, and transmit just the results of the execution to the edge device 1 rather than the application itself.

On the other hand, when the providing unit 2001 determines that the corresponding application is not stored in the function providing unit 2042, the providing unit 2001, in cooperation with the communication control unit 2002, transmits a transmission demand via the network Nb to an external server (which may be cloud server), the transmission demand requests transmission of the corresponding application. The transmission demand contains the application ID for the requested application.

The providing unit 2001, in cooperation with the communication control unit 2002, transmits to the edge device 1 the application transmitted from the external server in response to the transmission demand.

Note that when the corresponding application is not stored in the function providing unit 2042, the providing unit 2001 may, in cooperation with the communication control unit 2002, execute the corresponding application on an external server or the like by using an API in accordance with the batch files generated by the edge device 1. In this case, the providing unit 2001 may receive only the function execution results from the external server or the like and transmit these results to the edge device 1.

The communication control unit 2002 controls communication with the edge server 2 and the external server and transmits and receives various pieces of information.

Specifically, when the provision unit 2001 determines that the applications stored in the function providing unit 2042 include an application corresponding to the transmission demand, the communication control unit 2002, in cooperation with the providing unit 2001, transmits the corresponding application to the edge device 1 as a response to the provision demand.

When the providing unit 2001 determines that the applications stored in the function providing unit 2042 do not include an application corresponding to the transmission demand, the communication control unit 2002 transmits the transmission demand to an external server.

The communication control unit 2002 nay then receive an application transmitted from an external server in response to the transmission demand. The communication control unit 2002, in cooperation with the providing unit 2001, then transmits the received application to the edge device 1 as a response to the provision demand.

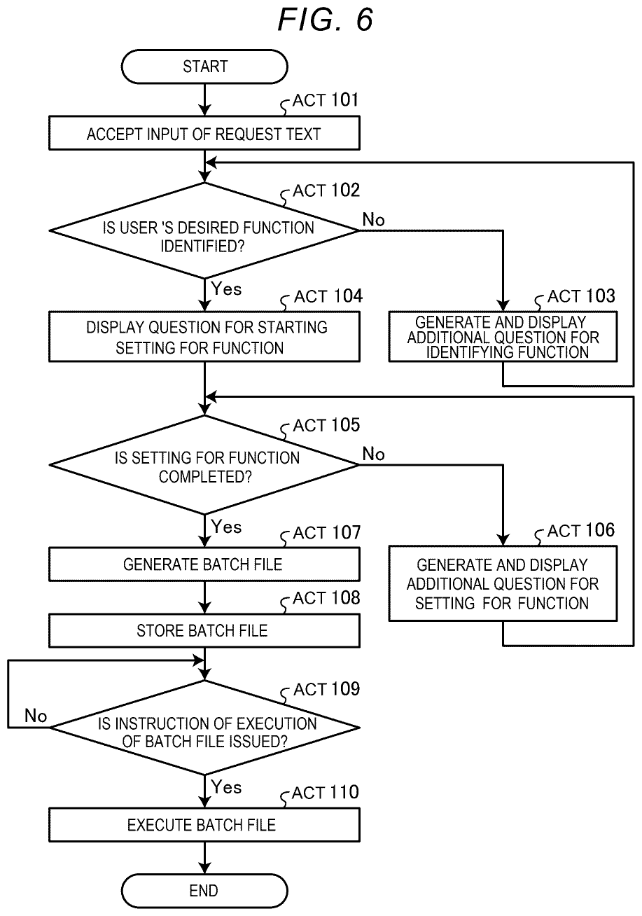

Processes carried out by the edge device 1 according to an embodiment will next be described. FIG. 6 is a flowchart showing an example of the processes carried out by the edge device 1.

The accepting unit 1001 first accepts input of a request text from the user (ACT 101). For example, the accepting unit 1001 accepts, as the request text, an answer input by the user in response to an identification start text generated by the dialogue LLM 1042 via the GUI for engaging in dialogue with the user for function construction.

The identifying unit 1002 then determines whether the user's desired function has been identified (ACT 102). For example, the identifying unit 1002 uses the RAG approach to cause the dialogue LLM 1042 to generate a dialogue text for identifying the user's desired function, and then determines whether the user's desired function has been identified based on the user's answer to the dialogue text.

When the user's desired function has not yet been identified (No in ACT 102), the identifying unit 1002, in consideration of previous interactions with the user, uses the RAG approach to instruct the dialogue LLM 1042 to generate additional dialogue text for identifying the user's desired function, then displays the generated dialogue text in the display field of the GUI (ACT 103), and returns to the process in ACT 102.

On the other hand, when the user's desired function has been identified (Yes in ACT 102), the setting unit 1003 uses the RAG approach to instruct the dialogue LLM 1042 to generate a setting start text for setting parameters and the like for the function, and displays the generated setting start text in the display field of the GUI (ACT 104).

The setting unit 1003 then determines whether the setting for the user's desired function has been completed (ACT 105). For example, when the setting unit 1003 acquires all information necessary for setting the function from a dialogue with the user via the dialogue LLM 1042, the setting unit 1003 determines that the setting for the function identified in ACT 102 has been completed. Generally, specific requirements (e.g., required parameters) for function setting are pre-established on a per function basis.

When the setting is not yet completed (No in ACT 105), the setting unit 1003, in consideration of previous interactions with the user, uses the RAG approach to instruct the dialogue LLM 1042 to generate an additional setting text (question) for setting the user's desired function, displays the generated setting text in the display field of the GUI (ACT 106), and returns to the process in ACT 105.

On the other hand, when the setting is completed (Yes in ACT 105), the generating unit 1004 generates a batch file or files (ACT 107).

For example, the generating unit 1004 inputs a question for identifying the function or a question for setting the function to the dialogue LLM 1042, and acquires information necessary for constructing the user's desired function, as described above. The generating unit 1004 generates one or more batch files based on the acquired information.

The generating unit 1004 then stores the batch file (s) (ACT 108). For example, the generating unit 1004 stores the batch files (generated in ACT 107) in the batch file storage unit 1045 of the memory unit 104.

The executing unit 1005 then determines whether an instruction for execution of a batch file is received from the user (ACT 109). When the execution instruction has not yet been received (No in ACT 109), the executing unit 1005 repeats the process in ACT 109.

On the other hand, when an execution instruction has been received (Yes in ACT 109), the executing unit 1005 executes the batch file (step 110) and ends the process.

For example, when all the applications for realizing the contents of the batch files are stored in the function providing unit 1044, the executing unit 1005 executes the applications stored in the function providing unit 1044 in combination in accordance with the contents of the batch files.

On the other hand, when the function providing unit 1044 does not include at least one of the necessary applications for realizing the contents of the batch files, the executing unit 1005 acquires the missing application from the edge server 2, and then executes the batch files.

As described above, the edge device 1 according to an embodiment accepts input of a request text indicating the content of a user's desired process. The request text and an instruction text instructing identification of a function that can realize the desired process is input to the dialogue LLM 1042, which then uses the vector DB 1043 as an information source and generates and outputs information according to the input information, identifies a function that can realize the content of the user's desired process based on a dialogue text output by the dialogue LLM 1042, and controls the edge device 1.

The edge device 1 thus allows the user to realize the user's desired function simply by inputting a sentence without having to, for example, set the order in which functions are called by using a flow design tool. Even a user without software design knowledge can therefore readily construct functions for the edge device 1. Furthermore, the edge device 1 according to an embodiment identifies the user's desired function by using vector DB 1043, which stores reference information relating to function construction, as the information source. Identification of a function outside those with information stored in the vector DB 1043 can thus be avoided. That is, the edge device 1 according to the embodiment allows the various possible functions of the edge device 1 that can be provided to end users to be readily implemented in various manners as appropriate to end user needs and preferences without the user having any pre-existing knowledge regarding the functions. Moreover, the edge device 1 according to an embodiment can construct the user's desired processing (functions) simply through a dialogue with the user as described above, and can therefore provide the user with an environment in which the functions of the edge device 1 can be implemented and combined without preparation of a complex UI (user interface) for such tasks. It is therefore also expected to provide an advantage of reducing the amount of UI development work associated with function construction and implementation.

The edge device 1 according to an embodiment causes the dialogue LLM 1042 to generate a question for identifying the user's desired function based on the information stored in the vector DB 1043, and identifies the user's desired function based on the user's answer (response) to the generated question.

The user simply answers questions generated by the dialogue LLM 1042 to have the edge device 1 perform a function. The dialogue LLM 1042 can prevent a situation in which functions beyond the capability of the edge device 1 are hallucinated by the LLM 1042 since questions and function-related text are generated in view of the vector DB 1043.

The edge device 1 according to an embodiment also identifies the setting content relating to the identified function using the dialogue LLM 1042 and the vector DB 1043. The setting content for the identified function is included in generated batch files for the execution of one or more applications for realizing the identified function.

The user can thus readily set the settable parameters or the like of function without also having to, for example, set the specific order in which functions are called by using a flow design tool. Furthermore, the edge device 1 according to an embodiment identifies the settings necessary for the user's desired function based on the information stored in the vector DB 1043. Identification of parameters and settings beyond the information stored in the vector DB 1043 can thus be avoided.

The edge device 1 according to an embodiment causes the dialogue LLM 1042 to generate a question for a setting of the user's desired function based on the information stored in the vector DB 1043, and then sets the user's desired function parameters/settings based on the user's answer to the question.

The user can therefore readily set the function by the user himself or herself by simply answering the question(s) generated by the dialogue LLM 1042.

The edge device 1 according to an embodiment can generate, along with the batch files, a setting file representing a setting content relating to the function. Therefore, for example, even when the user makes an unexpected mistake and is therefore unable to achieve the function desired, the user can investigate the cause of the malfunction by review of the setting content or the like.

The embodiment described above can be modified by changing part of the configuration or function of each of the apparatuses described above, and a modified embodiment can then be implemented. Some variations according to the embodiment described above will be described as other embodiments. The following description will be made primarily on points different from those already described above, and the points common to the already described contents will not be described in detail. These variations may be individually implemented or in combination as appropriate.

### (Variations)

In one embodiment, the controller 100 of the edge device 1 includes an accepting unit 1001, an identifying unit 1002, a setting unit 1003, a generating unit 1004, and an executing unit 1005 as a functional configuration. In other embodiments, controller 200 of the edge server 2 provides the functions of the units described above as functions of controller 100.

In this variation, the memory unit 204 of the edge server 2 includes the dialogue LLM 1042, the vector DB 1043, and the batch file storage unit 1045. The controller 200 of the edge server 2 carries out the described processes relating to the accepting unit 1001, the identifying unit 1002, the setting unit 1003, the generating unit 1004, and the executing unit 1005.

The memory unit 104 of the edge device 1 in this variation includes only the control program unit 1041. In this variation, the controller 100 of the edge device 1 only carries out the process of causing the display unit 106 to display various pieces of information, such as the results of the processes carried out by the edge server 2 and the process of accepting various inputs from the user via the operation unit 107.

Note that, in other examples, only some of the processes carried out by the accepting unit 1001, the identifying unit 1002, the setting unit 1003, the generating unit 1004, or the executing unit 1005 might be carried out by the edge server 2.

According to such variations, the process load on the edge device 1 can be reduced.

The programs executed by the information processing system S in an embodiment and variations thereof may be stored in a computer connected to a network, such as the Internet, and provided by downloaded or accessed via the network. In some examples, programs executed by the information processing system S may be provided or distributed via a network such as the Internet.

The programs executed by the apparatuses in the embodiment described above may be provided in the form of programs pre-installed in a ROM, a storage unit, or the like. In some examples, programs may be recorded on a non-transitory, computer-readable recording medium, such as a CD-ROM, a flexible disk (FD), a CD-R, or a DVD (digital versatile disk), and provided in an installable or executable format file.

Furthermore, programs above may be stored in a computer connected to a network such as the Internet and downloaded, accessed, or distributed via the network.

While certain embodiments have been described, these embodiments have been presented by way of examples only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. An information processing edge device, comprising:
a communication interface connectable to an edge server via a network;
a storage unit for storing a dialogue LLM trained to interact with a user for setting a function of an edge device and a database storing reference information related to functions of the edge device; and
a controller configured to:
receive request text input indicating a user's desired process to be provided using the edge device;
input the request text input to a generative AI based on the dialogue LLM and configured to access the database to identify a function that can be executed by the edge device to provide the user's desired process;
output confirmation question text generated by the generative AI to confirm the identified function corresponds to the user's desired process; and
set the edge device to execute the identified function if the user responds affirmatively to confirmation question text.

2. The information processing edge device according to claim 1, wherein the controller is further configured to:
cause the generative AI to generate a question for identifying the function, wherein
the request text input is received in response to the question.

3. The information processing edge device according to claim 1, wherein the controller is further configured to:
cause the generative AI to generate questions to the user for setting the request text input.

4. The information processing edge device according to claim 1, wherein setting the edge device to execute the identified function includes generating a batch file describing an execution procedure of one or more applications for realizing the identified function.

5. The information processing edge device according to claim 4, wherein the controller is further configured to:
output setting question text for setting parameters related to execution of the identified function,
set values for the parameters based on responses to the setting question text, and
store the set values for the parameters in the storage unit.

6. The information processing edge device according to claim 5, wherein the controller is further configured to:
generate setting question text by using the generative AI, wherein
the generative AI accesses the database to generate the setting question text.

7. The information processing edge device according to claim 1, wherein the controller is further configured to:
output setting question text for setting parameters related to execution of the identified function,
set values for the parameters based on responses to the setting question text, and
store the set values for the parameters in the storage unit.

8. The information processing edge device according to claim 1, wherein the controller is further configured to:
generate setting question text for setting parameters related to execution of the identified function by using the generative AI, wherein
the generative AI accesses the database to generate the setting question text.

9. The information processing edge device according to claim 1, wherein the identified function is retrieved from the edge server via the communication interface and then stored in the storage unit.

10. The information processing edge device according to claim 1, wherein the reference information is vectorized information of reference documents related to the functions of the edge device.

11. The information processing edge device according to claim 1, further comprising:
a sensor, wherein
the functions of the edge device relate to processing of output from the sensor.

12. The information processing edge device according to claim 11, wherein the sensor is an imaging unit.

13. An edge device, comprising:
a communication interface connectable to an edge server via a network;
an input unit for receiving user inputs;
a sensor for providing sensor output;
a storage unit for storing a dialogue LLM trained to interact with a user for setting an edge device function and a vector database storing reference information related to functions of the edge device; and
a controller configured to:
receive request text input via the input unit, the request text input indicating a user's desired process;
input the request text input to a generative AI based on the dialogue LLM and configured to access the vector database to identify an edge device function that can be executed by controller to provide the user's desired process;
output confirmation question text generated by the generative AI to confirm the identified edge device function corresponds to the user's desired process; and
set the controller to execute the identified edge device function if the user responds affirmatively to confirmation question text.

14. The edge device according to claim 13, wherein the controller is further configured to:
cause the generative AI to generate a question for identifying the edge device function, wherein
the request text input is received in response to the question.

15. The edge device according to claim 13, wherein setting the controller to execute the identified edge device function includes generating a batch file describing an execution procedure of one or more applications for realizing the identified edge device function.

16. The edge device according to claim 13, wherein the controller is further configured to:
output setting question text for setting parameters related to execution of the identified edge device function,
set values for the parameters based on responses to the setting question text, and
store the set values for the parameters in the storage unit.

17. The edge device according to claim 13, wherein the controller is further configured to:
generate setting question text for setting parameters related to execution of the identified edge device function by using the generative AI, wherein
the generative AI accesses the vector database to generate the setting question text.

18. The edge device according to claim 13, wherein the sensor is an imaging unit.

19. An edge device information processing method, comprising:
receiving request text input indicating a user's desired process to be provided using an edge device;
inputting the request text input to a generative AI based on a dialogue LLM and configured to access a reference database to identify a function that can be executed by the edge device to provide the user's desired process;
outputting confirmation question text generated by the generative AI to confirm the identified function corresponds to the user's desired process; and
setting the edge device to execute the identified function after the user responds affirmatively to confirmation question text, wherein
the dialogue LLM is trained to interact with a user for setting a function of an edge device and the reference database stores reference information related to functions of the edge device.

20. The edge device information processing method according to claim 19, wherein the reference information is vectorized information of reference documents related to the functions of the edge device.
